(19) United States
(12) Patent Application Publication
(10) Pub. No.: US 2011/0202791 A1
(43) Pub. Date: Aug. 18, 2011

(54) STORAGE CONTROL DEVICE , A STORAGE SYSTEM, A STORAGE CONTROL METHOD AND A PROGRAM THEREOF

(75) Inventors: Wataru SAITOU, Tokyo (JP); Masaya SUENAGA, Tokyo (JP)

(73) Assignee: NEC CORPORATION, Tokyo (JP)

(21) Appl. No.: 13/029,869

(22) Filed: Feb. 17, 2011

(30) Foreign Application Priority Data
Feb. 18, 2010 (JP) 2010-033348

(51) Int. Cl. G06F 11/07; G06F 12/02

(52) U.S. Cl. 714/6.12; 711/162; 711/E12.002; 714/E11.023

(57) ABSTRACT

A storage control device and a storage control method are provided. If a first failure detector of a first controller does not detect a failure in a second controller, a first input/output processor of the first controller copies the contents of a first volatile memory of the first controller to a second volatile memory of the second controller. On the other hand, if the first failure detector detects a failure in the second controller, the first input/output processor copies the contents of the first volatile memory to a first non-volatile memory of the first controller.

This application is based upon and claims the benefit of priority from Japanese patent application No. 2010-033348, filed on Feb. 18, 2010, the disclosure of which is incorporated herein in its entirety by reference.

### BACKGROUND

Exemplary embodiments described herein relate to a storage device, a storage system, a storage control method and a program thereof capable of maintaining the reliability and availability to a further failure even after a failure occurs in a part of the storage control device which is multiplexed.

In general, a storage system includes multiple storage devices and a storage control device. The storage devices serve as one or more logical volumes. The storage control device controls input and output of data to and from the logical volumes. The storage control device is connected to a host device.

The storage control device has a cache memory, and temporarily stores target data in the cache memory in accordance with an input/output request received from the host device. Here, in the case where the cache memory is configured of a volatile memory, when a failure occurs in the storage control device, the data which is stored in the cache memory and which is not stored in the storage devices may be lost. Accordingly, a multiplexed storage control device has been developed.

For example, the storage control device described in Japanese Patent Application Publication No. 2008-217527 (hereinafter, Patent Document 1) includes multiple volatile memories and multiple non-volatile memories. And target input/output data is stored in the multiple volatile memories, and further the target input/output data is stored in the multiple non-volatile memories. Then the target input/output data stored in a part of the volatile memories is deleted. When a failure occurs in a one of the volatile memories, the target input/output data is stored in another of the volatile memories in which no failure has occurred and in the multiple nonvolatile memories.

Furthermore, for example, the storage control device described in Japanese Patent Application Publication No. 2008-276646 (hereinafter, Patent Document 2) makes a cache mechanism duplex, which has a volatile memory and a non-volatile memory. In the volatile memory, target input/output data received from a host device and the data read from a storage device are stored. On the other hand, in the non-volatile memory, only the data read from the storage device is stored. When a power cut failure occurs, this storage control device backs up data to the non-volatile memory. The data backed up is data which is stored in the volatile memory and which is not consistent with the data stored in the storage device.

In the Patent Document 1, when a failure occurs in one of the volatile memories, the storage control device backs up the target input/output data. However, the storage control device does not back up the data which is already stored in the volatile memories. Accordingly, in the state where a failure has occurred in on of the volatile memories, for a further failure, it takes time for the storage control device to recover the volatile memories to the original state before the occurrence of the failures.

Also, in the Patent Document 2, the storage control device transfers the data stored in the volatile memory to the non-volatile memory only after a power cut failure occurs. Thus, in the state where a failure occurs in one the cache mechanism, and the operation is maintained by a cache mechanism in which no failure has occurred, the storage control device has not backed up the data in the volatile memory. Thus reliability of the data in the volatile memory against a further failure is lowered.

As described above, the storage control devices described in the Patent Documents 1 and 2 have a problem in that when a failure occurs in one of the storage control devices which is multiplexed, reliability and availability against a further failure are lowered.

Note that the techniques disclosed in Patent Document 1 and Patent Document 2 are merely related techniques.

### SUMMARY OF THE INVENTION

According to an aspect of a non-limiting illustrative embodiment, there is provided a storage control device for maintaining the reliability and availability in the case of a further failure even after a failure occurs in a part of the storage control device which is multiplexed. If a first failure detector of a first controller does not detect a failure in a second controller, a first input/output processor of the first controller copies the contents of a first volatile memory of the first controller to a second volatile memory of the second controller. On the other hand, if the first failure detector detects a failure in the second controller, the first input/output processor copies the contents of the first volatile memory to a first non-volatile memory of the first controller.

According to an aspect of another exemplary embodiment, there is provided a storage system for maintaining the reliability and availability of the storage system in the case of a further failure even after a failure occurs in a part of the storage control device which is multiplexed.

According to an aspect of another exemplary embodiment, there is provided a storage control method for maintaining the reliability and availability of a storage control device in the case of a further failure even after a failure occurs in a part of the storage control device which is multiplexed.

According to an aspect of another exemplary embodiment, there is provided a computer readable medium recoding thereon a program for maintaining the reliability and availability of a storage control device in the case of a further failure even after a failure occurs in a part of the storage control device which is multiplexed.

### BRIEF DESCRIPTION OF THE DRAWINGS

Other exemplary aspects and advantages of various exemplary embodiments will become apparent by the following detailed description and the accompanying drawings, wherein:

FIG. 1 is a block diagram of a storage system in a first exemplary embodiment.

FIG. 2 is a flowchart explaining operation of the storage system.

FIG. 3 is a block diagram of a storage system in a second exemplary embodiment.

FIG. 4 is a flowchart explaining failure monitoring operation of the storage system.

FIG. 5 is a flowchart explaining input/output processing operation of the storage system.

### DETAILED DESCRIPTION

A first exemplary embodiment is described in detail below by referring to the drawings.

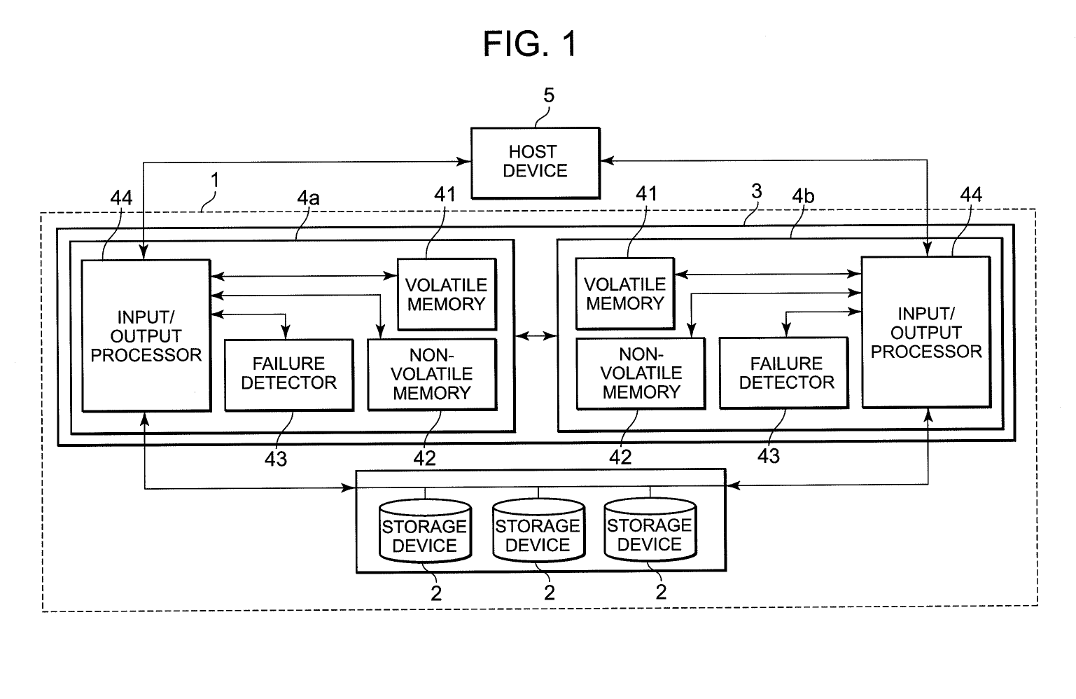

First, the configuration of a storage system in the first exemplary embodiment is described using FIG. 1.

In FIG. 1, the storage system includes a storage apparatus 1 and a host device 5. The storage apparatus 1 includes one or more storage devices 2 and a storage control device 3. The storage control device 3 is connected to the host device 5.

The storage devices 2 are multiplexed. The storage devices 2 provide one or more logical volumes to the host device 5, and they store the data inputted and outputted by the host 5. For example, the storage devices 2 are configured as devices that can store the data processed by the host device 5, such as hard disk drives, DVD (Digital Versatile Disc) drives, magnetic tape drives, and flash storage devices, as well as a combination of these.

FIG. 1 shows three storage devices 2. However, this is not intended to limit the number of storage devices according to exemplary embodiments.

The host device 5 processes the data which is read from the storage devices 2, and stores the processed data in the storage devices 2. For example, the host device 5 may be a computer apparatus, or some other storage apparatus.

The host device 5 and the storage apparatus 1 are communicatively connected to each other. For example, the host device 5 and the storage apparatus 1 may be connected to each other via a network such as a LAN (Local Area Network), the Internet, a dedicated line, and a SAN (Storage Area Network), or a combination of these.

The storage control device 3 has controllers 4a and 4b (hereinafter, sometimes collectively referred to as a controller 4) that control input/output of data to and from the storage devices 2. These controllers 4a and 4b are connected to each other via a bus. Also, the controller 4 is connected to the storage devices 2 via connection interfaces.

FIG. 1 shows two controllers 4a and 4b. However this is not intended to limit the number of controllers included in the storage apparatus of exemplary embodiments.

Each of the controller 4a and 4b includes a volatile memory 41, a non-volatile memory 42, a failure detector 43, and an input/output processor 44.

Here, the volatile memory 41 may be a DRAM (Dynamic Random Access Memory), for example. The non-volatile memory 42 may be a flash memory, for example. The failure detector 43 and the input/output processor 44 may be a microprocessor and a local memory, for example. And the failure detector 43 and the input/output processor 44 function by reading the programs stored in the local memory and executing the programs using a part of the local memory as a task space. The entire or a part of the function of the failure detector 43 and the input/output processor 44 may also be implemented by a hardware circuit, for example.

The failure detector 43 of one controller (e.g. controller 4a) detects that a failure has occurred in the other controller (e.g. controller 4b) by communicating with the components of the other controller.

The input/output processor 44 receives an input/output request of data into or from the storage devices 2 from the host device 5, and stores the target input/output data in the volatile memory 41.

Specifically, the input/output processor 44, when receiving a write request of data into the storage devices 2 from the host device 5, stores the target write data in the volatile memory 41. Also, the input/output processor 44 transfers the target write data stored in the volatile memory 41 to the storage devices 2 asynchronously to the operation of storing the target write data in the volatile memory 41.

Also, the input/output processor 44, when receiving a read request of data stored in the storage devices 2 from the host device 5, transfers the target read data from the volatile memory 41 to the host device 5 if the target read data is actually stored in the volatile memory 41. Otherwise, if the target read data is not stored in the volatile memory 41, the input/output processor 44 reads the target read data from the storage devices 2, and transfers the data to the host device 5.

If the target read data is not stored in the volatile memory 41, the input/output processor 44 may read the data from the storage devices 2 to transfer the data to the host device 5 instead of via the volatile memory 41.

Also, if a failure has not occurred in the other controller, the input/output processor 44 makes the volatile memory 41 and the volatile memory 41 of the other controller redundant. Also, if a failure has occurred in the other controller, the input/output processor 44 makes the volatile memory 41 and the non-volatile memory 42 redundant. In other words, for example, if the failure detector 43 of the controller 4a detects that a failure has not occurred in the controller 4b, the input/output processor 44 of the controller 4a copies the data stored in the volatile memory 41 of the controller 4a to the volatile memory 41 of the controller 4b; and if the failure detector 43 of the controller 4a detects that a failure has occurred in the controller 4b, the input/output processor 44 of the controller 4a copies the volatile memory 41 of the controller 4a to the non-volatile memory 42 of the controller 4a.

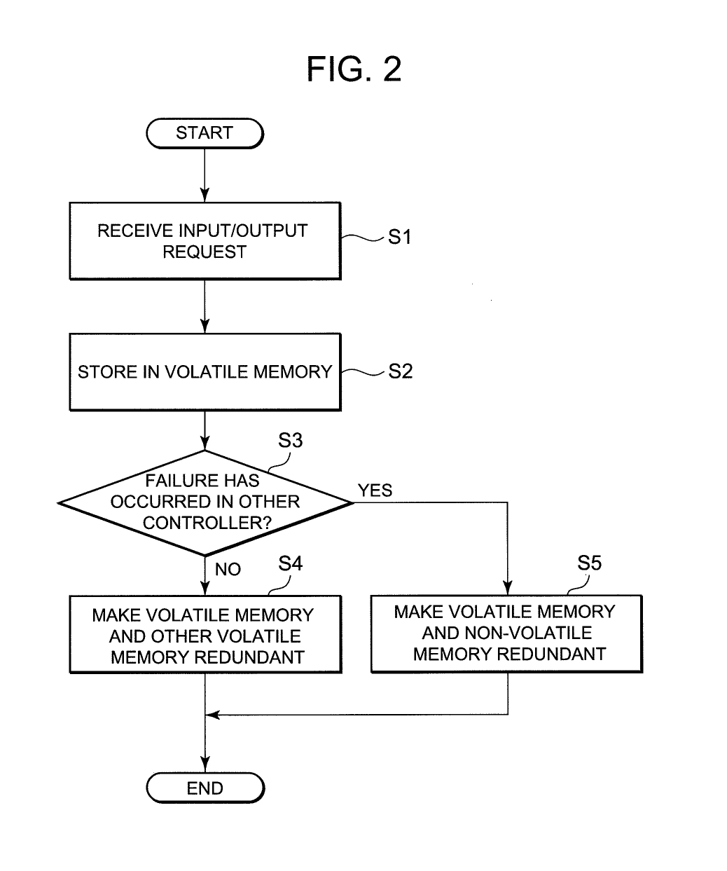

Operation of the storage system as shown above is described using FIG. 2.

First, an input/output request of data is received from the host device 5 by the input/output processor 44 of the controller 4a (operation S1: input/output request receiving operation).

Next, the target input/output data is stored in the volatile memory 41 of the controller 4a by the input/output processor 44 of the controller 4a (operation S2: volatile memory storing operation).

Next, it is determined by the input/output processor 44 of the controller 4a whether or not a failure has been detected in the controller 4b by the failure detector 43 of the controller 4a (operation S3: failure detection operation).

Here, when a failure has not been detected in the controller 4b, the volatile memory 41 of the controller 4a and the volatile memory 41 of the controller 4b are made redundant by the input/output processor 44 of the controller 4a (operation S4: volatile memory redundancy operation).

On the other hand, when a failure has been detected in the controller 4b, the volatile memory 41 and the non-volatile memory 42 of the controller 4a are made redundant by the input/output processor 44 of the controller 4a (operation S5: non-volatile memory redundancy operation).

Then, the storage apparatus 1 terminates the operation.

Note that the operation in the case where the controller 4b receives an input/output request of data from the host apparatus 5 can be also described similarly by replacing the controllers 4a and 4b respectively with the controllers 4b and 4a in the above description.

Next, an advantageous effect of the first exemplary embodiment is described.

In this embodiment, it is possible to maintain the reliability and availability against a further failure even after a failure occurs in a part of the storage control device which is multiplexed.

This is because the input/output processor makes the volatile memories included in the respective multiple controllers redundant in a normal condition (when there is no failure detected, the data of one volatile memory is copied to the other volatile memory), and when a failure occurs in one of the controllers, the input/output processor makes redundant the volatile memories and non-volatile memories of those controllers in which no failure has occurred (when there is a failure detected in another controller, the data of the volatile memory is copied to the non-volatile memory). Thus, even when a failure occurs in one of the controllers, the data in the volatile memories are still made redundant.

Next, a second exemplary embodiment is described in detail by referring to the drawings.

The second exemplary embodiment is described by way of an example in which the storage apparatus is applied to a disk array apparatus.

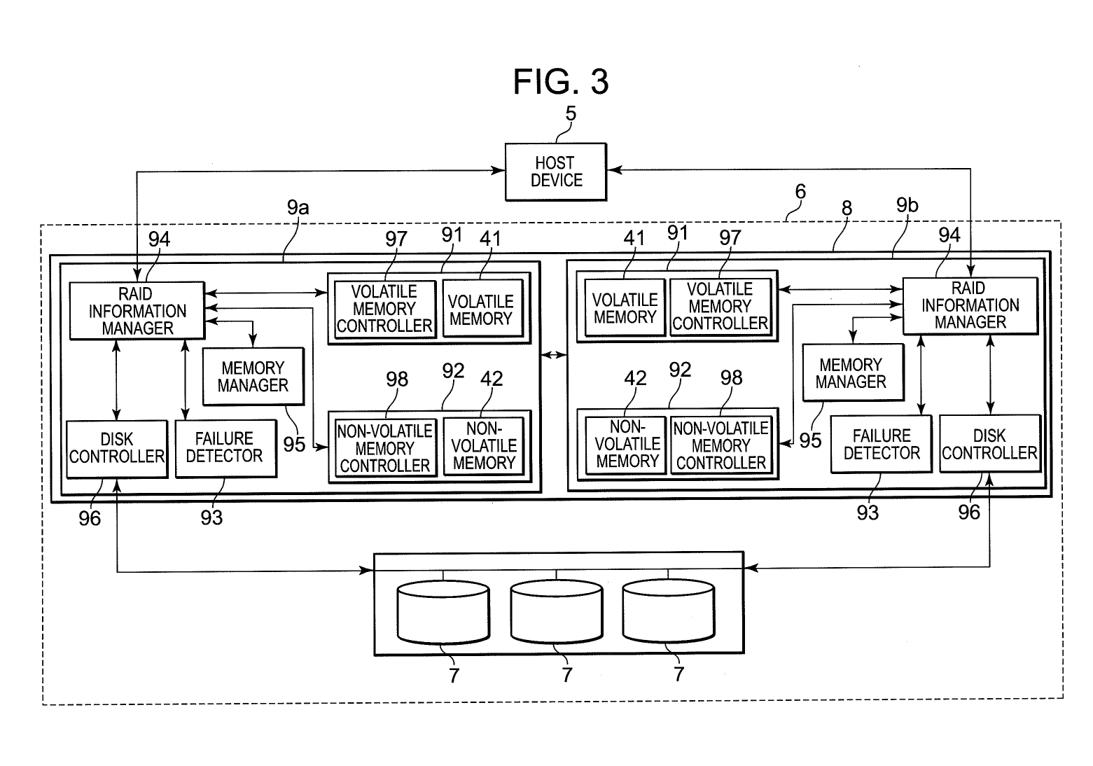

First, the configuration of a disk array apparatus 6 as the second exemplary embodiment is described using FIG. 3. In FIG. 3, the same components as those of the storage apparatus 1 as the first exemplary embodiment are denoted by the same reference numerals, and detailed description thereof is omitted.

The disk array apparatus 6 includes multiple hard disks 7 and a storage control device 8, and is communicatively connected to the host device 5 similarly to the storage apparatus 1 in the first exemplary embodiment.

The multiple hard disks 7 may be one or more RAID (Redundant Arrays of Independent Disks) groups, and provides the storage spaces of the RAID groups as logical volumes to the host device 5. FIG. 3 shows three hard disks 7. However this is not intended to limit the number of storage devices included in the storage apparatus of exemplary embodiments.

The storage control device 8 manages the multiple hard disks 7 by the RAID configuration, and has controllers 9a and 9b (hereinafter, sometimes collectively referred to as a controller 9) that control input/output of data.

The controller 9 is connected to the hard disks 7 via connection interfaces. Also, the controllers 9a and 9b are connected to each other via a bus.

FIG. 3 shows two controllers 9a and 9b. However this is not intended to limit the number of controllers included in the storage apparatus of exemplary embodiments.

Each of the controllers 9a and 9b includes a volatile memory unit 91, a non-volatile memory unit 92, a failure detector 93, a RAID information manager 94, a memory manager 95, and a disk controller 96. Also, the volatile memory unit 91 includes the volatile memory 41 and a volatile memory controller 97. Moreover, the non-volatile memory unit 92 includes the non-volatile memory 42 and a non-volatile memory controller 98.

Here, the RAID information manager 94, the memory manager 95, the disk controller 96, the volatile memory controller 97, and the non-volatile memory controller 98, together, serve as an example of an input/output processor.

Furthermore, the failure detector 93, the RAID information manager 94, the memory manager 95, the disk controller 96, the volatile memory controller 97, and the non-volatile memory controller 98 each have a microprocessor and a local memory. And they function by reading the programs stored in the local memory and executing the programs using a part of the local memory as a task space. The entirety or a part of the function of each of these components may also be a hardware circuit.

The volatile memory controller 97 performs processing on the volatile memory 41, such as reading, writing, and deleting data, checking the presence or absence of data, and providing redundancy, under the control of the RAID information manager 94.

The non-volatile memory controller 98 performs processing on the non-volatile memory 42, such as reading, writing, and deleting data, checking the presence or absence of data, and providing redundancy, under the control of the RAID information manager 94.

Also, the non-volatile memory controller 98 controls the non-volatile memory 42 in either a secondary cache mode or a redundancy mode. In the case of the secondary cache mode, the non-volatile memory controller 98 stores target write data exceeding the capacity of the volatile memory 41 into the non-volatile memory 42. In the case of the redundancy mode, the non-volatile memory controller 98 makes target write data, the management data, and other data in the volatile memory 41 redundant by writing these data into the non-volatile memory 42.

The failure detector 93 of one of the controllers (e.g. controller 9a) detects a failure having occurred in the other controller (e.g. controller 9b) by communicating with each component in the other controller. Here, failures to be detected by the detector 93 include a failure of the power supply (not shown) that supplies power to each component and other failures, in addition to any failure which may occur in any of the components shown in FIG. 3.

The failure detector 93 in one controller also detects a recovery from a failure having occurred in the other controller. The failure detector 93 notifies the RAID information manager 94 of an occurrence of and recovery from a failure in the other controller.

The RAID information manager 94 receives a write request and a read request to and from the hard disks 7 from the host device 5, processes the request, and transmits a completion notification of the processing to the host device 5.

Specifically, the RAID information manager 94, when receiving a write request from the host device 5, issues a write instruction to the volatile memory controller 97, and stores target write data in the volatile memory 41.

Also, the RAID information manager 94 makes the volatile memory 41 redundant with either the volatile memory 41 in the other controller or the non-volatile memory 42 in the same controller, according to whether a failure has occurred in the other controller or not.

Also, the RAID information manager 94, when completing to temporarily store the target write data in the volatile memory 41 and to make the volatile memory 41 redundant, transmits a completion notification of the write processing to the host device 5.

Also, the RAID information manager 94 issues a write instruction to the disk controller 96, and transfers the target write data stored in the volatile memory 41 to the hard disks 7 asynchronously to the write processing.

In the case where the free space in the volatile memory 41 for storing the target write data is insufficient (e.g. in controller 9a), and no failure has occurred in the other controller (e.g. controller 9b), the RAID information manager 94 issues a write instruction to the non-volatile memory controller 98, and stores the target write data in the non-volatile memory 42 (of the controller 9a).

Meanwhile, in the case where the free space in the volatile memory 41 for storing the target write data is insufficient (e.g. in controller 9a), and a failure has occurred in the other controller (e.g. controller 9b), the RAID information manager 94 (of the controller 9a) issues a write instruction to the disk controller 96, and stores the target write data in the hard disks 7.

The RAID information manager 94, when receiving a read request from the host device 5, checks with the volatile memory controller 97 whether the target read data is in the volatile memory 41 or not. When the target read data is in the volatile memory 41, the RAID information manager 94 transfers the target read data from the volatile memory 41 to the host device 5. The RAID information manager 94 then transmits a completion notification of the read processing to the host device 5.

When the target read data is not in the volatile memory 41, the RAID information manager 94 issues a read instruction to the disk controller 96, and transfers the target read data from the hard disks 7 to the host device 5. The RAID information manager 94 then transmits a completion notification of the read processing to the host device 5.

The memory manager 95 changes the mode of the non-volatile memory 42 to either the secondary cache mode or the redundancy mode.

Specifically, the memory manager 95 of one controller (e.g. controller 9a), when detecting a failure having occurred in the other controller (e.g. controller 9b) via the RAID information manager 94, changes the mode of the non-volatile memory 42 to the redundancy mode. Furthermore, the memory manager 95, when detecting a recovery from a failure having occurred in the other controller (e.g. controller 9b) via the RAID information manager 94, changes the mode of the non-volatile memory 42 to the secondary cache mode.

Here, the memory manager 95 may store a flag in the local memory, the flag indicating whether the non-volatile memory 42 is in the secondary cache mode or the redundancy mode.

Also, the memory manager 95, when changing the mode of the non-volatile memory 42 to the redundancy mode, writes unwritten data in the non-volatile memory 42 to the hard disks 7. Specifically, when there is some data in the non-volatile memory 42 which has not been written to the hard disks 7 yet out of the target write data stored in the secondary cache mode, the memory manager 95 issues a high-speed write instruction to the disk controller 96, and transfers the unwritten data from the non-volatile memory 42 to the hard disks 7. Subsequently, the memory manager 95 changes the mode of the non-volatile memory 42 to the redundancy mode.

When the capacity of the non-volatile memory 42 is greater than that of the volatile memory 41, the memory manager 95 may change the mode of the free space in the non-volatile memory 42, which is not used for the secondary cache mode, to the redundancy mode, and may continue to manage the remaining space in the secondary cache mode.

In this case, when the free space in the non-volatile memory 42 is smaller than a capacity required to make the volatile memory 41 redundant, the memory manager 95 may continue to store unwritten data in the non-volatile memory 42 into the hard disks 7 until free space with the required capacity can be reserved, and may delete the unwritten data from the non-volatile memory 42.

The disk controller 96 is connected to the hard disks 7 via a connection interface, and executes reading of the target read data from the hard disks 7. Also, the disk controller 96 generates a redundancy code of the target write data as needed according to the level of the RAID being configured, and stores the target write data and the redundancy code in the multiple hard disks 7 in a distributed manner.

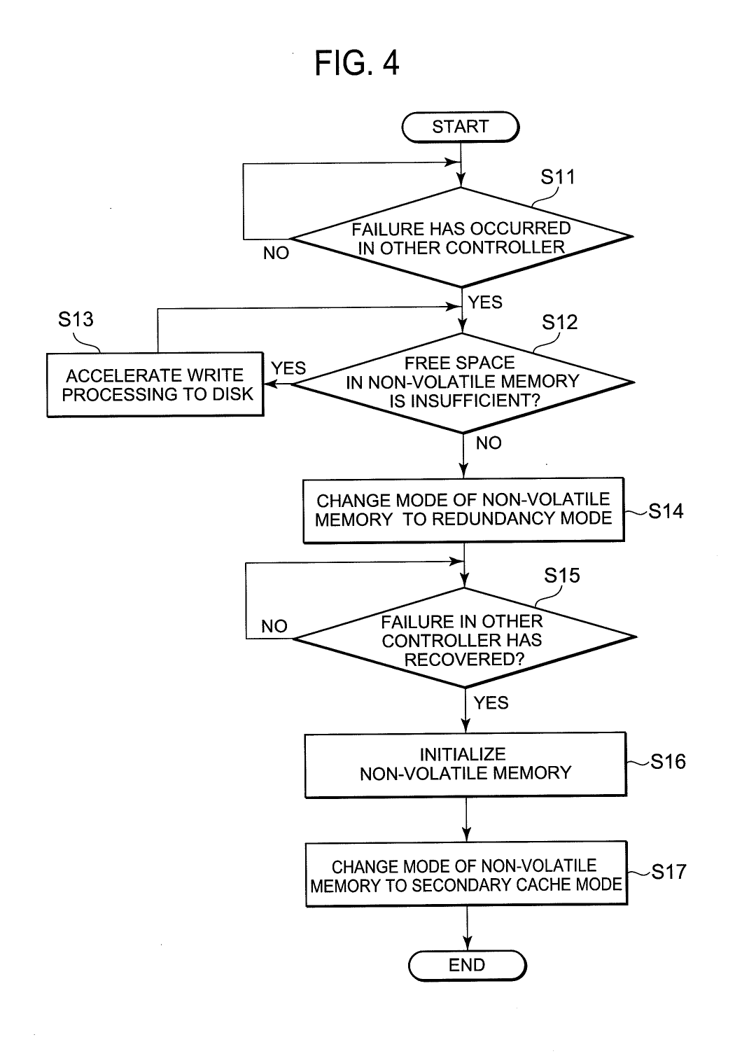

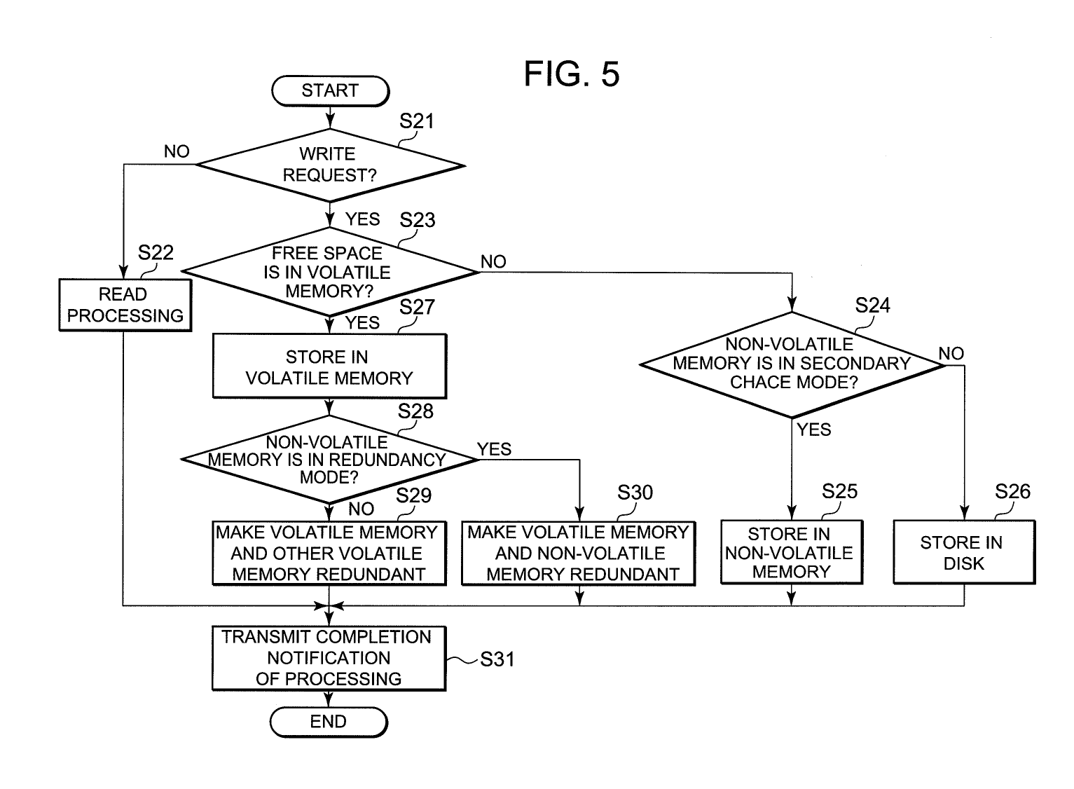

Operation of the storage control device 8 in the disk array apparatus 6 as configured above is described using FIGS. 4 and 5.

First, the operation by the controller 9a of the storage control device 8 for monitoring failure which may occur in the controller 9b is shown in FIG. 4. The controller 9a periodically performs this failure monitoring operation shown in FIG. 4.

Here, when a failure having occurred in the controller 9b is detected by the failure detector 93 of the controller 9a (Yes in operation S11), the memory manager 95 of the controller 9a determines whether the free space in the non-volatile memory 42 is smaller than a capacity required to make the volatile memory 41 redundant or not (operation S12).

Here, when it is determined that the free space is smaller, a high-speed write instruction is issued to the disk controller 96 by the memory manager 95 of the controller 9a.

Then, write processing of the unwritten data stored in the non-volatile memory 42 to the hard disks 7 is accelerated by the disk controller 96 of the controller 9a (operation S13). The write processing of the unwritten data to the hard disks 7 is continued until the free space in the non-volatile memory 42 gains the capacity required to make the volatile memory 41 redundant.

On the other hand, when it is determined that the free space in the non-volatile memory 42 is sufficient, the mode of the free space in the non-volatile memory 42 is changed to the redundancy mode by the memory manager 95 of the controller 9a (operation S14).

Next, when a recovery from the failure having occurred in the controller 9b is detected by the failure detector 93 of the controller 9a (Yes in operation S15), the space of the non-volatile memory 42 used for the redundancy mode is initialized by the non-volatile memory controller 98 of the controller 9a (operation S16).

Next, the mode of the non-volatile memory 42 is changed to the secondary cache mode by the memory manager 95 of the controller 9a (operation S17).

Then, the controller 9a of the storage control device 8 terminates the monitoring operation of failure occurring in the controller 9b.

Note that the operation by the controller 9b for monitoring failure which may occur in the controller 9a can be also described similarly by replacing the controllers 9a and 9b respectively with the controllers 9b and 9a in the above description.

Next, the operation by the controller 9a of the storage control device 8 for processing an input/output request received from the host device 5 is described using FIG. 5.

Here, it is first determined by the RAID information manager 94 of the controller 9a whether the input/output request received from the host device 5 is a write request or a read request (operation S21).

Here, when a read request is received and target read data is in the volatile memory 41, the target read data is transmitted to the host device 5 by the RAID information manager 94. Otherwise, when the target read data is not in the volatile memory 41, the target read data read from the hard disks 7 via the disk controller 96 is transmitted to the host device 5 by the RAID information manager 94 (operation S22).

On the other hand, when a write request is received, it is determined by the RAID information manager 94 whether there is a sufficient free space in the volatile memory 41 to store the target write data or not (operation S23).

Here, when it is determined that the free space in the volatile memory 41 is insufficient, the RAID information manager 94 checks with the memory manager 95 whether the non-volatile memory 42 is in the secondary cache mode or in the redundancy mode (operation S24).

Here, when the non-volatile memory 42 is in the secondary cache mode, a write instruction is issued to the non-volatile memory controller 98 by the RAID information manager 94, and target write data is stored in the non-volatile memory 42 (operation S25).

On the other hand, when the non-volatile memory 42 is in the redundancy mode, a write instruction is issued to the disk controller 96 by the RAID information manager 94, and target write data is written to the hard disks 7 (operation S26).

When it is determined that the free space in the volatile memory 41 has a sufficient capacity in operation S23, a write instruction is issued to the volatile memory controller 97 by the RAID information manager 94, and the target write data is stored in the volatile memory 41 (operation S27).

Next, the RAID information manager 94 checks with the memory manager 95 whether the non-volatile memory 42 is in the redundancy mode or in the secondary cache mode (operation S28).

Here, when the non-volatile memory 42 is in the secondary cache mode, this indicates that no failure has occurred in the controller 9b. Then, the volatile memory controllers 97 of the controllers 9a and 9b communicate with each other via the RAID information managers 94, and the volatile memories 41 of the controllers 9a and 9b are made redundant (operation S29).

On the other hand, when the non-volatile memory 42 is in the redundancy mode, this indicates that a failure has occurred in the controller 9b. Then, the volatile memory controller 97 and the non-volatile memory controller 98 of the controller 9a communicate with each other via the RAID information manager 94, and the volatile memory 41 and the non-volatile memory 42 are made redundant (operation S30).

Next, the RAID information manager 94 transmits information indicating the completion of input/output processing to the host device 5 (operation S31).

Then, the controller 9a of the storage control device 8 terminates the input/output processing operation.

The input/output processing operation of the controller 9b can be also described similarly by replacing the controllers 9a and 9b respectively with the controllers 9b and 9a in the above description.

Next, exemplary advantageous of the second exemplary embodiment are described.

In the second exemplary embodiment, it is possible to prevent reduction in the input/output processing performance when a failure occurs in a part of the storage control device which is multiplexed.

This is because when the volatile memories and non-volatile memories included in the controllers in which no failure has occurred are made redundant, completion of the input/output information processing is notified to the host device. That is to say, even in a situation where a failure has occurred in one of the controllers, reliability and availability against an occurrence of a further failure can be secured by making the volatile memory redundant, and write-back control can be performed without waiting for the completion of writing to the hard disks.

In addition, in the second exemplary embodiment, it is possible to effectively utilize the non-volatile memory when no failure has occurred, and to maintain the input/output processing performance even when a load to the volatile memory is high.

This is because when no failure has occurred in one of the controllers, write-back control can be performed on the host device by using the non-volatile memory as a secondary cache which stores the data whose capacity exceeds that of the volatile memory.

Furthermore, it is possible to maintain the input/output processing performance even when a failure occurs in one of the controllers, and the volatile memory of the controller in which no failure has occurred has a high load.

This is because write-back control can be performed by using a part of the non-volatile memory for making the volatile memory redundant, and using the remaining space as a secondary cache, even when a failure occurs in one of the controllers and the volatile memory of the controller in which no failure has occurred has a high load.

In each of the above-described embodiments, the non-volatile memory may be configured to be detachable, for example, as a PCI (Peripheral Components Interconnect)—Express interface connection type flash memory.

According to exemplary embodiments, when a failure occurs in one of the controllers and later a further failure occurs, it is possible to reduce the operation suspension time until the failure is recovered.

This is because the data in the volatile memory is held in the detachable non-volatile memory; thus, the controller after the replacement can be easily recovered to the original state before a failure occurrence by attaching the non-volatile memory before the replacement to the controller after the replacement.

In the above-described exemplary embodiments, the operation of the storage control device may be performed by a microprocessor stored in a local memory of each controller as a program module included in the storage control program.

Furthermore, the features discussed with respect to the above-described exemplary embodiments may be re-combined and implemented combinations in addition to those described above, as needed, as would be understood by one of skill in the art.

The above-described exemplary embodiments are non-limiting, and can be implemented in various forms.

Although exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A storage control device, comprising:
a first controller configured to control an input and an output of data to and from a storage device; and
a second controller configured to control an input and an output of data to and from the storage device,
wherein the first controller comprises a first volatile memory, a first non-volatile memory, a first failure detector configured to detect a failure in the second controller, and a first input/output processor configured to store data in the first volatile memory in response to an input/output request,
wherein the second controller comprises a second volatile memory, a second non-volatile memory, a second failure detector configured to detect a failure in the first controller, and a second input/output processor configured to store data in the second volatile memory in response to an input/output request,
wherein if the first failure detector does not detect a failure in the second controller, the first input/output processor copies the contents of the first volatile memory to the second volatile memory, and
wherein if the first failure detector detects a failure in the second controller, the first input/output processor copies the contents of the first volatile memory to the first non-volatile memory of the first controller.

2. The storage control device according to claim 1,
wherein after copying the contents of the first volatile memory to the second volatile memory or to the first non-volatile memory, the input/output processor transmits information indicating completion of input/output processing.

3. The storage control device according to claim 2,
wherein when the input/output request is received, if a capacity of the first volatile memory is insufficient, the first input/output processor stores the data in a part of the first non-volatile memory.

4. The storage control device according to claim 3,
wherein if the first failure detector detects the failure in the second controller and a free space of the first non-volatile memory is smaller than a capacity required to copy the contents of the first volatile memory, the input/output processor writes a data in the first non-volatile memory to the storage device.

5. The storage control device according to claim 1,
wherein upon a detection of a recovery from the failure in the second controller, the first input/output processor initializes a part of the first non-volatile memory in which the contents of the first volatile memory are copied.

6. A storage system, comprising:
a host device;
a storage device; and
a storage control device configured to control the storage device according to an input/output request of the host device;
wherein the storage control device comprises:
a first controller configured to control an input and an output of data to and from the storage device; and
a second controller configured to control an input and an output of data to and from the storage device,
wherein the first controller comprises a first volatile memory, a first non-volatile memory, a first failure detector configured to detect a failure in the second controller, and a first input/output processor configured to store data in the first volatile memory in response to an input/output request,
wherein the second controller comprises a second volatile memory, a second non-volatile memory, a second failure detector configured to detect a failure in the first controller, and a second input/output processor configured to store data in the second volatile memory in response to an input/output request, wherein if the first failure detector does not detect a failure in the second controller, the first input/output processor copies the contents of the first volatile memory to the second volatile memory, and
wherein if the first failure detector detects a failure in the second controller, the first input/output processor copies the contents of the first volatile memory to the first non-volatile memory of the first controller.

7. The storage system according to claim 6,
wherein after copying the contents of the first volatile memory to the second volatile memory or to the first non-volatile memory, the input/output processor transmits information indicating completion of input/output processing.

8. The storage system according to claim 7,
wherein when the input/output request is received, if a capacity of the first volatile memory is insufficient, the first input/output processor stores the data in a part of the first non-volatile memory.

9. The storage system according to claim 8,
wherein if the first failure detector detects the failure in the second controller and a free space of the first non-volatile memory is smaller than a capacity required to copy the contents of the first volatile memory, the input/output processor writes a data in the first non-volatile memory to the storage device.

10. The storage system according to claim 6,
wherein upon a detection of a recovery from the failure in the second controller, the first input/output processor initializes a part of the first non-volatile memory in which the contents of the first volatile memory are copied.

11. A storage control method of a storage control device comprising a first controller and a second controller, wherein the first controller includes a first volatile memory and a first non-volatile memory and the second controller includes a second volatile memory and a second non-volatile memory, the method comprising:
the first controller controlling an input and an output of data to and from a storage device;
detecting whether or not there is a failure in the second controller;
copying the contents of the first volatile memory to the second volatile memory if a failure in the second controller is not detected; and
copying the contents of the first volatile memory to the first non-volatile memory of the first controller if a failure in the second controller is detected.

12. The storage control method according to claim 11, further comprising:
transmitting information indicating completion of input/output processing after copying the contents of the first volatile memory to the second volatile memory or to the first non-volatile memory.

13. The storage control method according to claim 12, further comprising:
receiving an input/output request of the data;
storing the data in a part of the first non-volatile memory, if a capacity of the first volatile memory is insufficient.

14. The storage control method according to claim 13, further comprising:
if the failure in the second controller is detected and a free space of the first non-volatile memory is smaller than a capacity required to copy the contents of the first volatile memory, writing contents of the first non-volatile memory to the storage device.

15. The storage control method according to claim 11,
initializing a part of the first non-volatile memory in which the contents of the first volatile memory are copied, upon a detection of a recovery from the failure of the second controller.

16. A computer readable medium recording thereon a program for enabling a computer to perform a storage control method of a storage control device comprising a first controller and a second controller, wherein the first controller includes a first volatile memory and a first non-volatile memory and the second controller includes a second volatile memory and a second non-volatile memory, the method comprising:
the first controller controlling an input and an output of data to and from a storage device;
detecting whether or not there is a failure in the second controller;
copying the contents of the first volatile memory to the second volatile memory if a failure in the second controller is not detected; and
copying the contents of the first volatile memory to the first non-volatile memory of the first controller if a failure in the second controller is detected.

17. The computer readable medium according to claim 16, the method further comprising:
transmitting information indicating completion of input/output processing after copying the contents of the first volatile memory to the second volatile memory or to the first non-volatile memory.

18. The computer readable medium according to claim 17, the method further comprising:
receiving an input/output request of the data;
storing the data in a part of the first non-volatile memory, if a capacity of the first volatile memory is insufficient.

19. The computer readable medium according to claim 18, the method further comprising:
if the failure in the second controller is detected and a free space of the first non-volatile memory is smaller than a capacity required to copy the contents of the first volatile memory, writing contents of the first non-volatile memory to the storage device.

20. The computer readable medium according to claim 16, the method further comprising:
initializing a part of the first non-volatile memory in which the contents of the first volatile memory are copied, upon a detection of a recovery from the failure of the second controller.
